(19) United States
(12) Patent Application Publication
(10) Pub. No.: US 2020/0198045 A1
(43) Pub. Date: Jun. 25, 2020

(54) METHOD OF KEEPING A SCRIBER TIP CLEAR OF MATERIAL AND AN ABLATION SCRIBER HEAD

(71) Applicant: TF Massif Technologies Ltd., Burnaby (CA)

(72) Inventors: Alain CAREL, Vancouver (CA); Kimball ANDERSEN, Coquitlam (CA)

(21) Appl. No.: 16/725,320

(22) Filed: Dec. 23, 2019

(30) Foreign Application Priority Data
Dec. 21, 2018 (CA) 3028480

(51) Int. Cl. B23K 9/26; B23K 9/16; B23K 9/013; B08B 5/02

(52) U.S. Cl. CPC B23K 9/26; B08B 5/02; B23K 9/013; B23K 9/164

(57) ABSTRACT

A method of keeping a scriber tip clear of ablated material that uses an ablation scriber head constructed in accordance with the teachings of the method. The ablation scriber head directs pressurized gas at the scriber tip to keep the scriber tip clear of ablated material. It is preferred that the pressurized gas contains an oxidizing agent which oxidizes the ablated material.

### FIELD

There is described a method of keeping a scriber tip clear of material an ablation scriber head. The method and ablation scriber head were developed for engraving circuits on metal, but have wider application.

### BACKGROUND

A scriber is a tool with a tip having a sharp point used in metal working for scribing lines on a metal substrate. With an ablation scriber, an electric field is created between the tip and a conductive metal substrate. The sharp point of the tip amplifies the electric field between the conductive metal substrate and the tip, facilitating the formation of an arc as the tip comes into proximity with the conductive metal substrate. This arc is used to ablate material from the conductive metal substrate.

The creation of engraving of circuits on metal substrates is almost always done through chemical etching. This is most often done using screen printed masks to protect the areas which will be conductive, and to allow the conductive material to be removed from the rest of the substrate.

Scribing can be used to remove thin tracks of material from a conductive coating on a substrate, however it is often difficult to ensure that the tracks are uniform, and the scribed-off material does not short across the tracks. An ablation type scriber can help with the formation of larger, harder to short tracks, however the ablated material tends to build-up on the tip. This build-up of ablated material adversely effects the quality of the circuit, often rendering it unusable for the intended purpose.

There are arc ablation techniques that use a dielectric fluid to prevent this build-up, but for very large area systems this can be difficult to implement. In addition, this fluid needs to be cleaned off the substrate after etching.

### SUMMARY

According to one aspect there is provided a method of keeping a scriber tip clear of material. The method involves directing pressurized gas at the scriber tip to keep the scriber tip clear of material.

For better results, it is preferred that the pressurized gas reacts with the material. Beneficial results have been obtained when the pressurized gas contains an oxidizing agent which oxidizes the ablated material. As will hereinafter further explained, a reducing gas could also be used.

It has been found that even better results are obtained when the pressurized gas is directed in an angular configuration to create a rotating vortex around the scriber tip. It has also been found the better results are obtained when the pressurized gas is pulsed.

According to another aspect there is provided an ablation scriber head that includes a body with a scriber tip supported by the body. An electrical connection is provided whereby the scriber tip is coupled to an electric power source. An array of gas nozzles surround the scriber tip. A gas connection is provided whereby the array of gas nozzles are coupled to a source of pressurized gas. Pressurized gas passes through the gas connection to the array of gas nozzles, with the gas nozzles directing the pressurized gas at the scriber tip to keep the scriber tip clear of ablated material.

As described above in relation to the method, it is preferred that the pressurized gas be one that reacts with the ablated material to keep the scriber tip clear of the ablated material. Beneficial results have been obtained when the pressurized gas contains an oxidizing agent which oxidizes the ablated material.

As described above in relation to the method, it is preferred that the array of gas nozzles are placed in an angular configuration so that the pressurized gas exiting the gas nozzles creates a rotating vortex around the scriber tip.

As described above in relation to the method, it is preferred that a valve is positioned to control a flow of gas from the gas connection to the array of nozzles, thereby allowing a pulsing of the pressurized gas by mechanized opening and closing of the valve.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of an ablation scriber head.

FIG. 2 is a top perspective view of the ablation scriber head of FIG. 1.

FIG. 3 is a bottom perspective view of the ablation scriber head of FIG. 1.

FIG. 4 is a detailed bottom perspective view of FIG. 3.

FIG. 5 is a section view of FIG. 1, with a pulsing valve in an open position.

FIG. 6 is a section view of FIG. 1, with the pulsing valve in a closed position.

FIG. 7 is a section view of FIG. 1, at scriber tip of the ablation scriber head.

### DETAILED DESCRIPTION

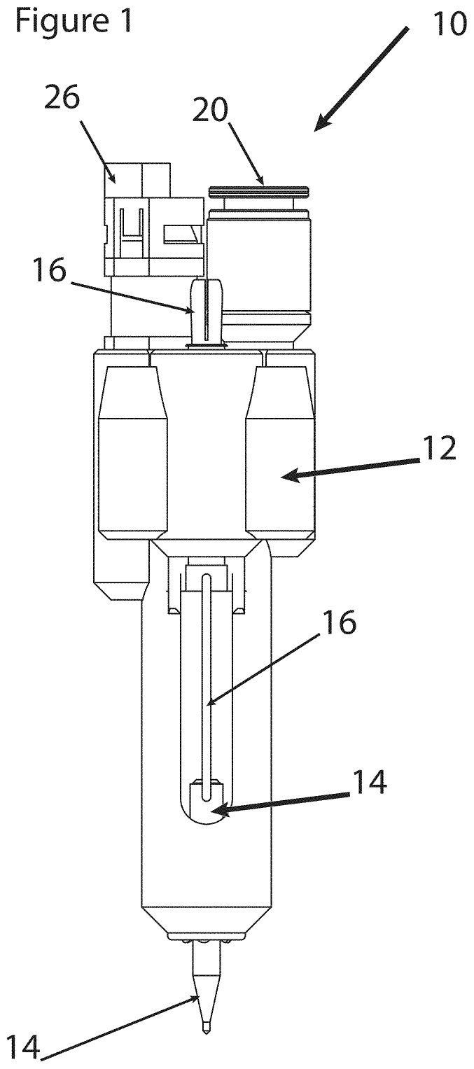

An ablation scriber head generally identified by reference numeral 10, will now be described with reference to FIG. 1 through FIG. 7.

A method was developed to keep a scriber tip clear of material. The best known method involved directing pressurized gas at the scriber tip to keep the scriber tip clear of material, with the pressurized gas being directed in an angular configuration to create a rotating vortex around the scriber tip. It was determined that the method was most effective when the pressurized gas actually reacted with the material. For example, beneficial results were obtained when the pressurized gas contained an oxidizing agent which oxidized the ablated material. It was also determined that a pulsing of the pressurized gas brought better results that a constant velocity flow.

It will be understood that the method can be used with non-electrified heads. However, with the method in mind, ablation scriber head 10 was developed, which happens to be electrified.

### Structure and Relationship of Parts

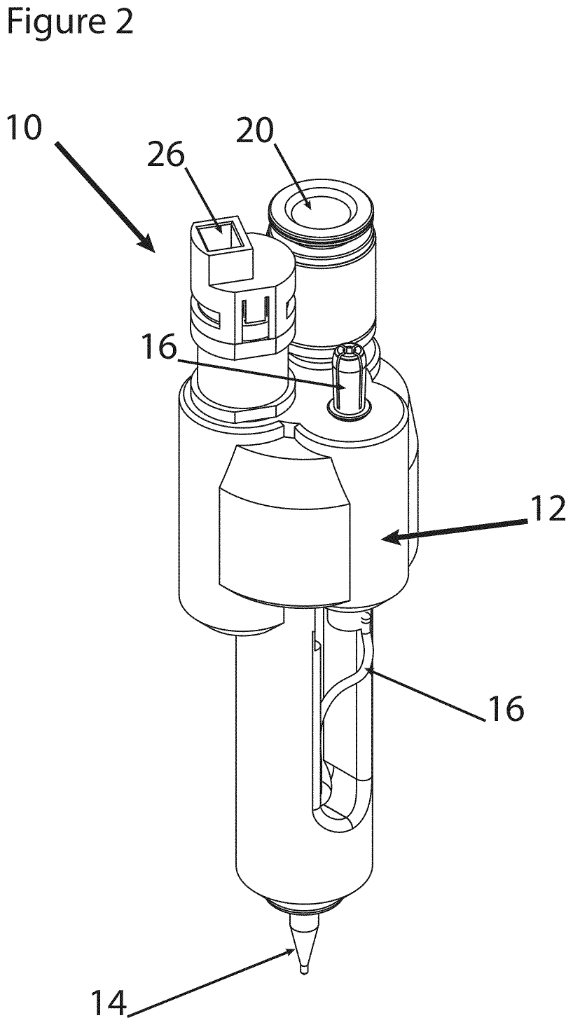

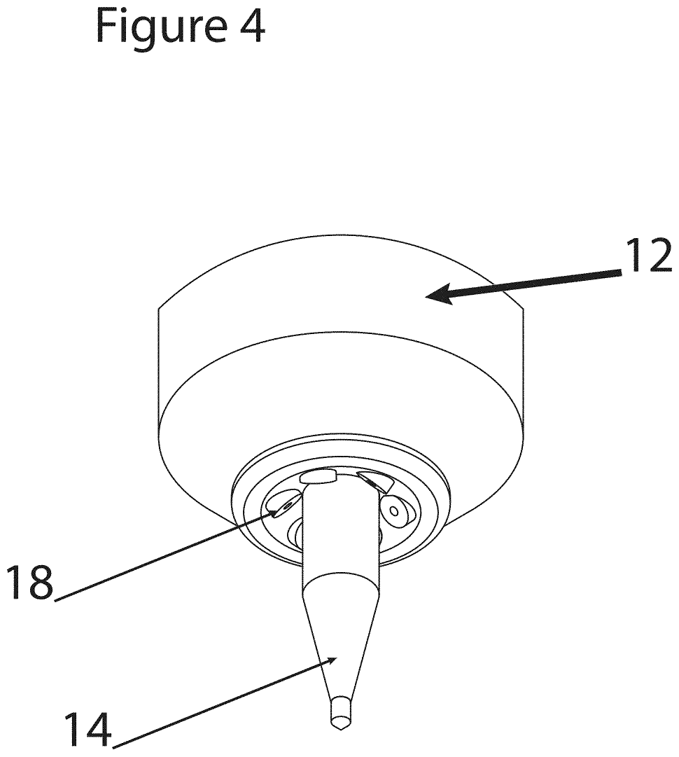

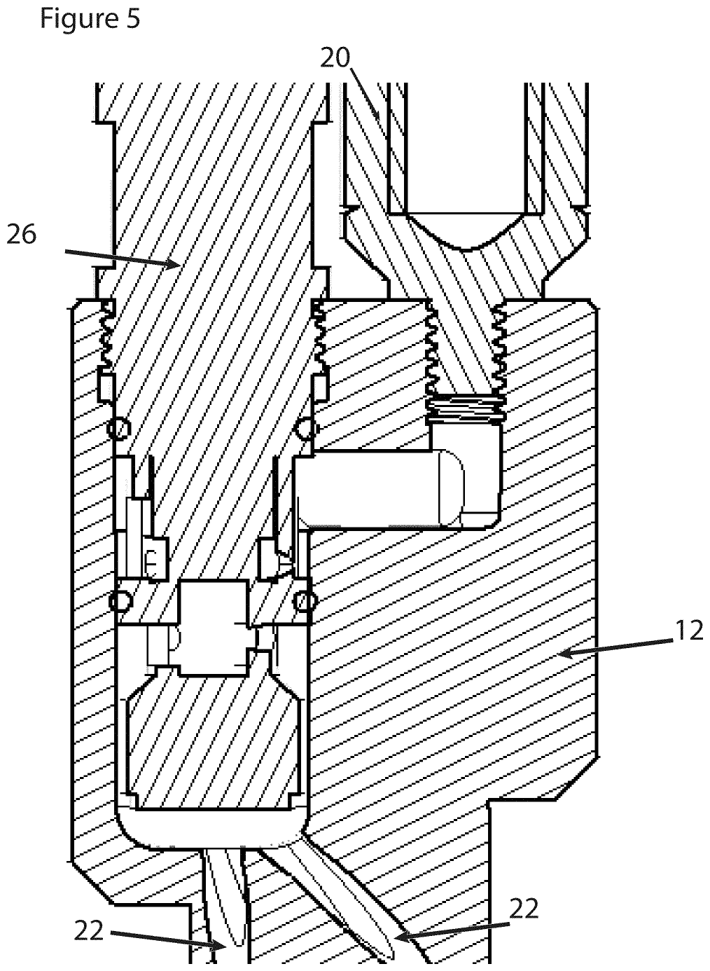

Referring to FIG. 1, ablation scriber head 10 consists of a body 12 and a scriber tip 14 supported by body 12. An electrical connection 16 is provided whereby scriber tip 14 is coupled to an electric power source (not shown). Referring to FIG. 4, an array of gas nozzles 18 surround scriber tip 14. Referring to FIG. 2, a gas connection 20 is provided whereby array of gas nozzles 18 are coupled to a source of pressurized gas (not shown). Referring to the section view of FIG. 5, arrows 22 show the path pressurized gas passes through gas connection 20 to array of gas nozzles 18. Referring to FIG. 4, it can be seen that gas nozzles 18 direct pressurized gas at scriber tip 14.

It is preferred that the pressurized gas be one that reacts with ablated materials. The desired reaction can be obtained through the use of an oxidizing gas. An oxidizing agent may be added to the pressurized gas to oxidize the ablated material to keep scriber tip 14 clear of ablated material. For example when the material being scribed is a reactive metal such as copper, the oxidizing agent that may be used is oxygen and the carrier gas is nitrogen. Through the use of a shielding gas, oxidation could be prevented in order to protect delicate substrate materials, as well as reduce sparking, such as with metals like aluminium. A reducing gas, such as ammonia, could also be employed to help with etching of oxide based materials, such as Indium Tin Oxide (ITO).

Referring to FIG. 4, array of gas nozzles 18 is arranged in an angular configuration. Arrows 24 show how the pressurized gas exiting gas nozzles 18 creates a rotating vortex around scriber tip 14.

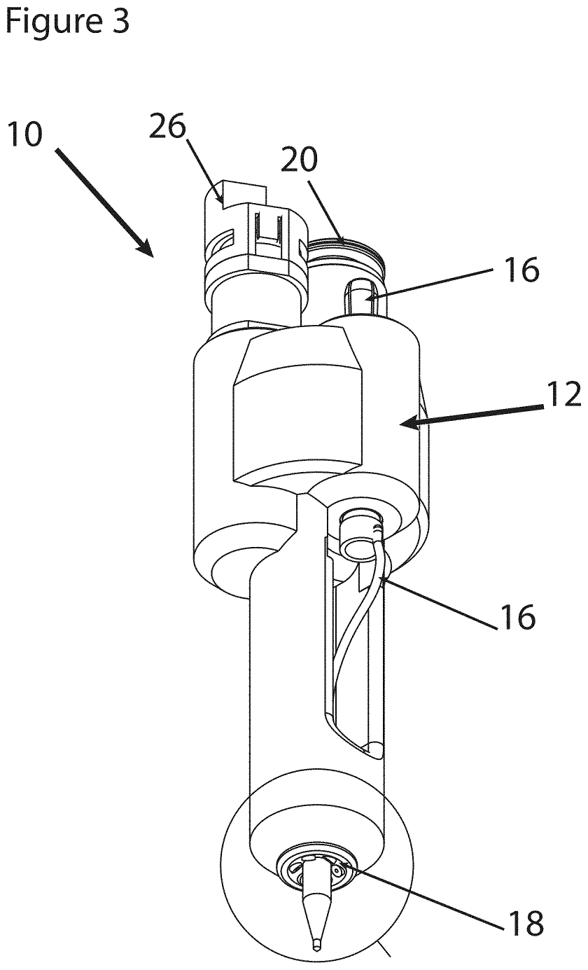

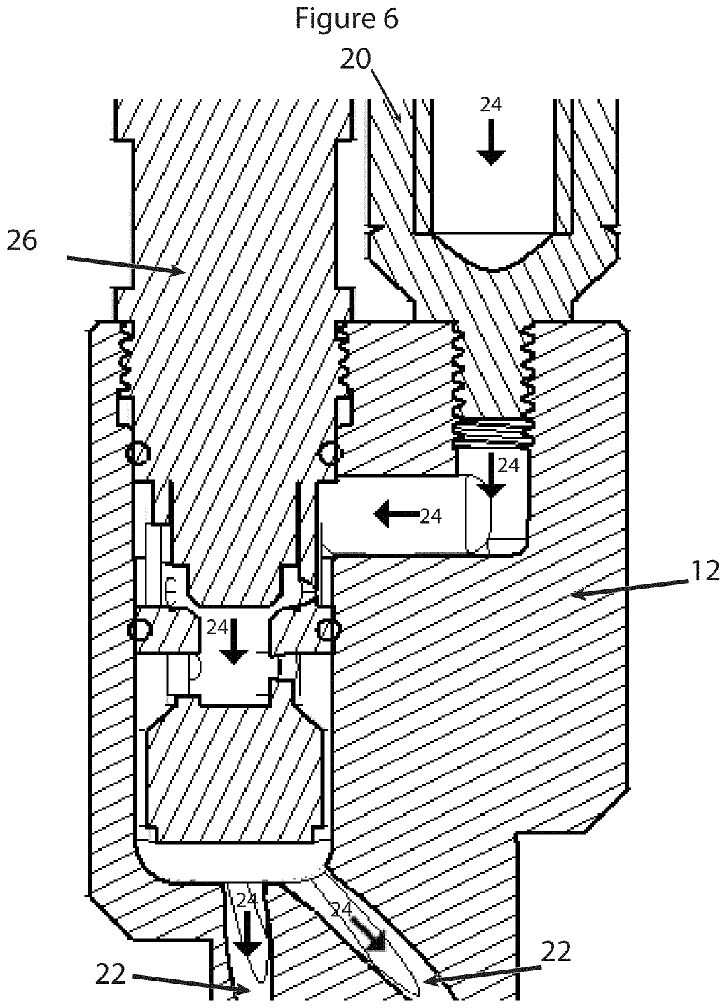

Referring to FIG. 3, a valve 26 is provided. Referring to the section view of FIG. 5 and FIG. 6, it can be seen that valve 26 is positioned to control a flow of gas from gas connection 20 to array of nozzles 18. This allows a pulsing of the pressurized gas by mechanized opening and closing of valve 26.

The material out of which scriber tip 14 is made, has been found to be important for performance. To ensure longevity, it is preferred that a high molecular weight metal, such as Tungsten, is used. It will be understood that there are other high molecular weight materials, like gold or rare earth metals, that would also work. Also, the atomic bonding strength is important, so ceramic-like materials like Tungsten carbide are advantageous. The amount of energy needed to remove an electron is also an important factor (lower is better), so one other specific possibility would be Lanthanum Hexaboride.

### Operation

Referring to FIG. 1, in operation, electric power is provided to scriber tip 14 via electrical connection 16. Scriber tip 14 “floats” in the sense that it is actually free to move up and down. Scriber tip 14 is spring biased, which allows scriber tip 14 to accommodate imperfections in the surface of the material. The downward force provided by the spring maintains contact the scriber tip 14 in constant contact with the material. When fully engaged with the workpiece, scriber tip is generally pushed up into the housing to some degree. In the illustrated embodiment electrical connection 16 is an electrical wire that serves double duty as a biasing spring, which allows the scriber tip to “float” as described above. It will be appreciated that there are other ways of biasing scriber tip 14. For example, weight can create a downward bias or magnetic repulsion can create a downward bias.

As scriber tip 14 engages a workpiece, ablated material invariably cling to scriber tip 14. Referring to the section view of FIG. 5 and FIG. 6, arrows 22 show the path pressurized gas passes through gas connection 20 to array of gas nozzles 18. Referring to FIG. 4, array of gas nozzles 18 is arranged in an angular configuration. Arrows 24 show how the pressurized gas exiting gas nozzles 18 creates a rotating vortex around scriber tip 14.

Referring to the section view of FIG. 5 and FIG. 6, it can be seen that valve 26, which controls the flow of pressurized gas from gas connection 20 to array of nozzles 18 is used to “pulse” the flow of pressurized gas by opening and closing of valve 26.

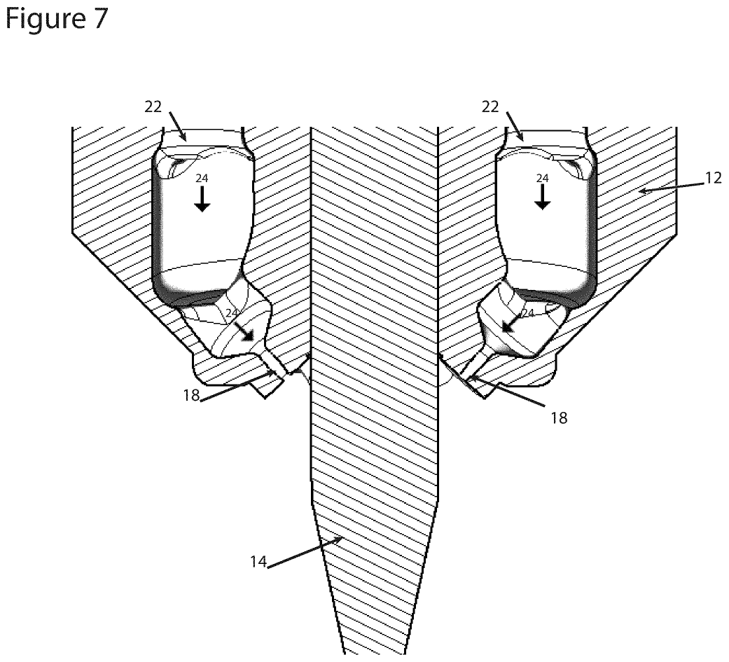

Referring to FIG. 7, is can be seen the flow of pressurized gas through nozzles 18.

In addition to the velocity of the pulsing pressurized gas, an oxidizing agent in the pressurized gas serves to oxidize the ablated material to keep scriber tip 14 clear of ablated material.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of keeping a scriber tip clear of material, comprising:
directing pressurized gas at the scriber tip to keep the scriber tip clear of material.

2. The method of claim 1, wherein the pressurized gas reacts with the material to keep the scriber tip clear of the material.

3. The method of claim 2, wherein the pressurized gas contains an oxidizing agent which oxidizes the material.

4. The method of claim 2, wherein the pressurized gas is a reducing gas.

5. The method of claim 4, wherein the reducing gas is ammonia.

6. The method of claim 1, wherein the pressurized gas is directed in an angular configuration to create a rotating vortex around the scriber tip.

7. The method of claim 1, wherein the pressurized gas is pulsed.

8. A method of keeping a scriber tip clear of ablated material, comprising:
directing pressurized gas at the scriber tip to keep the scriber tip clear of ablated-scribed material, the pressurized gas being directed in an angular configuration to create a rotating vortex around the scriber tip, the pressurized gas being pulsed, the pressurized gas containing an oxidizing agent which oxidizes the ablated-scribed material.

9. An ablation scriber head, comprising:
a body;
a scriber tip supported by the body;
an electrical connection whereby the scriber tip is coupled to an electric power source;
an array of gas nozzles surrounding the scriber tip;
a gas connection whereby the array of gas nozzles are coupled to a source of pressurized gas, such that pressurized gas passes through the gas connection to the array of gas nozzles, the gas nozzles directing the pressurized gas at the scriber tip to keep the scriber tip clear of material.

10. The ablation scriber head of claim 9, the pressurized gas reacting with the material to keep the scriber tip clear of the material.

11. The ablation scriber head of claim 10, wherein the pressurized gas contains an oxidizing agent which oxidizes the material.

12. The ablation scriber head of claim 10, wherein the pressurized gas is a reducing gas.

13. The ablation scriber head of claim 9, wherein the array of gas nozzles are placed in an angular configuration so that the pressurized gas exiting the gas nozzles creates a rotating vortex around the scriber tip.

14. The ablation scriber head of claim 9, wherein a valve is positioned to control a flow of gas from the gas connection to the array of nozzles, thereby allowing a pulsing of the pressurized gas by mechanized opening and closing of the valve.

15. The ablation scriber head of claim 9, wherein the scriber tip floats and has a downward bias.

16. An ablation scriber head, comprising:
a body;
a scriber tip supported by the body;
an electrical connection whereby the scriber tip is coupled to an electric power source;
an array of gas nozzles surrounding the scriber tip;
a gas connection whereby the array of gas nozzles are coupled to a source of pressurized gas, such that pressurized gas passes through the gas connection to the array of gas nozzles, the gas nozzles directing the pressurized gas at the scriber tip, the pressurized gas contains an oxidizing agent which oxidizes the ablated-scribed material to keep the scriber tip clear of ablated-scribed material;
the array of gas nozzles being in an angular configuration so that the pressurized gas exiting the gas nozzles creates a rotating vortex around the scriber tip; and
a valve being positioned to control a flow of gas from the gas connection to the array of nozzles, thereby allowing a pulsing of the pressurized gas by mechanized opening and closing of the valve.
